SEQUENCE LISTING (24 sequences)

SEQ ID NO: 1 - protein, 46 aa, synthetic construct
NGLLIPQFLVASGGGGSRSIVTFSLRQNRGGGGSNGLLIPQFLVAS

SEQ ID NO: 2 - protein, 49 aa, synthetic construct
NGLLIPQFLVASGGGGSRALQALRALQALEALGGGGSNGLLIPQFLVAS

SEQ ID NO: 3 - protein, 49 aa, synthetic construct
NGLLIPQFLVASGGGGSRALRALQALEALEALGGGGSNGLLIPQFLVAS

SEQ ID NO: 4 - protein, 12 aa, synthetic construct
RSIVTFSLRQNR

SEQ ID NO: 5 - protein, 15 aa, synthetic construct
RALQALRALQALEAL

SEQ ID NO: 6 - protein, 15 aa, synthetic construct
RALRALQALEALEAL

SEQ ID NO: 7 - protein, 25 aa, synthetic construct
NGLLIPQFLVASGGGGSMSDYQMDM

SEQ ID NO: 8 - protein, 28 aa, synthetic construct
RALRALQALEALEALGGGGSMSDYQMDM

SEQ ID NO: 9 - protein, 28 aa, synthetic construct
RALQALRALQALEALGGGGSMSDYQMDM

SEQ ID NO: 10 - protein, 27 aa, synthetic construct
NGLLIPQFLVASGGGGSMDMQGRYMDR

SEQ ID NO: 11 - protein, 30 aa, synthetic construct
RALRALQALEALEALGGGGSMDMQGRYMDR

SEQ ID NO: 12 - protein, 30 aa, synthetic construct
RALQALRALQALEALGGGGSMDMQGRYMDR

SEQ ID NO: 13 - protein, 5 aa, synthetic construct
GGGGS

SEQ ID NO: 14 - protein, 10 aa, synthetic construct
GGGGSGGGGS

SEQ ID NO: 15 - protein, 15 aa, synthetic construct
GGGGSGGGGSGGGGS

SEQ ID NO: 16 - protein, 22 aa, synthetic construct
GGGGSGGGGSGGGGSGGGGGGS

SEQ ID NO: 17 - protein, 8 aa, synthetic construct
GGGGGGGG

SEQ ID NO: 18 - protein, 6 aa, synthetic construct
GGGGGG

SEQ ID NO: 19 - protein, 5 aa, synthetic construct
EAAAK

SEQ ID NO: 20 - protein, 10 aa, synthetic construct
EAAAKEAAAK

SEQ ID NO: 21 - protein, 15 aa, synthetic construct
EAAAKEAAAKEAAAK

SEQ ID NO: 22 - protein, 46 aa, synthetic construct
AEAAAKEAAAKEAAAKEAAAKALEAAAAAKEAAAKEAAAKEAAAKA

SEQ ID NO: 23 - protein, 12 aa, synthetic construct
AEAAAKEAAAKA

SEQ ID NO: 24 - protein, 5 aa, synthetic construct
PAPAP

(19) United States
(12) Patent Application Publication
(10) Pub. No.: US 2025/0320433 A1
(43) Pub. Date: Oct. 16, 2025

(54) DETERGENTS COMPOSITIONS AND METHODS OF USING THE SAME

(71) Applicant: HENKEL AG & CO. KGAA, Düsseldorf (DE)

(72) Inventors: Daniel PIORKOWSKI, Fairfield, CT (US); Christian DEGERING, Erkrath (DE); Kyle Seamus Joseph O'CONNOR, Stamford, CT (US); Fabian FALKENBERG, Neuss (DE)

(21) Appl. No.: 19/094,931

(22) Filed: Mar. 30, 2025

Related U.S. Application Data
(60) Provisional application No. 63/572,535, filed on Apr. 1, 2024.

(51) Int. Cl. C11D 3/38; C11D 1/14; C11D 1/22; C11D 1/72; C11D 1/83; C11D 3/00; C11D 3/04; C11D 3/20; C11D 3/48

(52) U.S. Cl. CPC C11D 3/38; C11D 1/83; C11D 3/0036; C11D 3/046; C11D 3/201; C11D 3/2044; C11D 3/2079; C11D 3/48; C11D 1/146; C11D 1/22; C11D 1/72

(57) ABSTRACT

Detergent compositions include peptides, anionic surfactants, non-ionic surfactants, and water. The peptides are designed to enhance cleaning efficiency and textile care. The peptides included in the composition have binding domains with a high affinity for textiles and amino acids susceptible to oxidation, which serve as effective chlorine scavengers, thereby preserving fabric color and enhancing enzyme cleaning performance. Additional components may include a linking domain, a fatty acid, a strong base, a weak acid, an anti-redeposition polymer, a preservative, a chelating agent, and a linear alkyl benzene sulfonic acid.

### CROSS-REFERENCE TO RELATED APPLICATION

This application claims the benefit of U.S. Provisional Application No. 63/572,535, filed Apr. 1, 2024, the entire contents of which is incorporated by reference herein.

### SEQUENCE LISTING

The instant application contains a Sequence Listing which has been submitted electronically in XML format and is hereby incorporated by reference in its entirety. Said XML copy, created on Jun. 11, 2025, is named 166830-00255_SL.xml and is 22,081 bytes in size.

### FIELD OF THE INVENTION

This disclosure generally relates to liquid detergent compositions and methods of using the same. More specifically, this disclosure generally relates to liquid detergent compositions containing peptides.

### BACKGROUND

In liquid detergent compositions, amino acids such as lysine can provide a benefit with scavenging chlorine. This is of importance since wash water sourced from the city contains chlorine as a sanitization agent against microbes (so it is potable/drinkable). Chlorine is known to deteriorate fabrics' dyes over time, especially when they are red, blue or black dyes. This dye deterioration may be seen in 3 to 30 washes, if not controlled. Lysine has been shown to remove chlorine from the wash, as quickly as seconds. In addition to fabric dye damage, not controlling chlorine in the water can negatively impact enzyme performance for cleaning.

### SUMMARY OF THE INVENTION

Various aspects of the present disclosure are directed to liquid detergent compositions and methods of using the same.

In some instances, a first aspect of the disclosure can be described as a liquid detergent composition comprising, consisting essentially of, or consisting of a peptide, a non-ionic surfactant, an anionic surfactant, and water.

In some instances, a second aspect of the disclosure can be described as a liquid detergent composition according to the first aspect, wherein the peptide comprises one or more binding domains having a binding affinity to a textile, and two or more amino acids susceptible to oxidation.

In some instances, a third aspect of the disclosure can be described as a liquid detergent composition according to the first or second aspect, wherein the peptide is in an amount ranging from about 0.01 to about 5 wt % of the detergent composition, the non-ionic surfactant is in an amount ranging from about 1 to about 30 wt % of the detergent composition, and the anionic surfactant in an amount ranging from about 1 to about 35 wt % of the detergent composition.

In some instances, a fourth aspect of the disclosure can be described as a liquid detergent composition according to any one of the first through third aspects, wherein the peptide further comprises a linking domain.

In some instances, a fifth aspect of the disclosure can be described as a liquid detergent composition according to the fourth aspect, wherein the linking domain comprises GGGGS_(SEQ ID NO: 13) or EAAAK (SEQ ID NO: 19).

In some instances, a sixth aspect of the disclosure can be described as a liquid detergent composition according to any one of the first through fifth aspects, wherein the peptide has a length of about 5 to about 70 amino acids.

In some instances, a seventh aspect of the disclosure can be described as a liquid detergent composition according to any one of the first through sixth aspects, wherein the peptide has a length of about 10 to about 60 amino acids.

In some instances, an eight aspect of the disclosure can be described as a liquid detergent composition according to any one of the first through seventh aspects, wherein about 3.3% to about 20% of the amino acids in the peptide are amino acids susceptible to oxidation.

In some instances, a ninth aspect of the disclosure can be described as a liquid detergent composition according to any one of the first through fifth aspects or seventh and eight aspects, wherein about 10 to about 60 amino acids in the peptide are amino acids susceptible to oxidation.

In some instances, a tenth aspect of the disclosure can be described as a liquid detergent composition according to any one of the second through ninth aspects, wherein the amino acids susceptible to oxidation are cysteine, histidine, methionine, arginine, or lysine.

In some instances, an eleventh aspect of the disclosure can be described as a liquid detergent composition according to any one of the second through tenth aspects, wherein each amino acid susceptible to oxidation is no more than 5 amino acids away from an amino acid in one of the one or more binding domains.

In some instances, a twelfth aspect of the disclosure can be described as a liquid detergent composition according to any one of the first through eleventh aspects, wherein the peptide comprises any one of SEQ ID NO. 1-SEQ ID NO. 6.

In some instances, a thirteenth aspect of the disclosure can be described as a liquid detergent composition according to any one of the first through eleventh aspects, wherein the peptide comprises any one of SEQ ID NO. 7-SEQ ID NO. 12.

In some instances, a fourteenth aspect of the disclosure can be described as a liquid detergent composition according to any one of the first through thirteenth aspects, wherein the liquid detergent composition further comprises a fatty acid. In some instances, the fatty acid can be present in an amount ranging from about 0.1 to about 3 wt % of the detergent composition.

In some instances, a fifteenth aspect of the disclosure can be described as a liquid detergent composition according to any one of the first through fourteenth aspects, wherein the liquid detergent composition further comprises a strong base. In some instances, the strong base can be present in an amount ranging from about 0.1 to about 10 wt % of the detergent composition.

In some instances, a sixteenth aspect of the disclosure can be described as a liquid detergent composition according to any one of the first through fifteenth aspects, wherein the liquid detergent composition further comprises a weak acid. In some instances, the weak acid can be present in an amount ranging from about 1 to about 9 wt % of the detergent composition.

In some instances, a seventeenth aspect of the disclosure can be described as a liquid detergent composition according to any one of the first through sixteenth aspects, wherein the liquid detergent composition further comprises an anti-redeposition polymer. In some instances, the anti-redeposition polymer can be present in an amount ranging from about 0.1 to about 3 wt % of the detergent composition.

In some instances, an eighteenth aspect of the disclosure can be described as a liquid detergent composition according to any one of the first through seventeenth aspects, wherein the liquid detergent composition further comprises a preservative. In some instances, the preservative can be present in an amount ranging from about 0.01 to about 2 wt % of the detergent composition.

In some instances, a nineteenth aspect of the disclosure can be described as a liquid detergent composition according to any one of the first through eighteenth aspects, wherein the liquid detergent composition further comprises a chelating agent. In some instances, the chelating agent in an amount ranging from about 0.1 to about 3 wt % of the detergent composition.

In some instances, a twentieth aspect of the disclosure can be described as a liquid detergent composition according to any one of the first through nineteenth aspects, wherein the liquid detergent composition further comprises a linear alkyl benzene sulfonic acid. In some instances, the linear alkyl benzene sulfonic acid is in an amount ranging from about 5 to about 10 wt % of the detergent composition.

In some instances, a twenty-first aspect of the disclosure can be described as a liquid detergent composition according to any one of the first through twentieth aspects, wherein the liquid detergent composition further comprises one or more of a microbiocide, an algicide, and a fungicide. In some instances, the one or more of a microbiocide, an algicide, and a fungicide are in a combined amount ranging from about 0.01 to about 3 wt % of the detergent composition.

In some instances, a twenty-second aspect of the disclosure can be described as a liquid detergent composition according to any one of the first through twenty-first aspects, wherein the liquid detergent composition further comprises an aqueous enzyme solution. In some instances, the aqueous enzyme solution comprises one or more of a protease, a mannanase, and an amylase. In some instances, the aqueous enzyme solution is in an amount ranging from about 0.1 to about 5 wt % of the detergent composition.

In some instances, a twenty-third aspect of the disclosure can be described as a liquid detergent composition according to any one of the first through twenty-second aspects, wherein the liquid detergent composition further comprises sodium tetraborate. In some instances, the sodium tetraborate is in an amount ranging from about 0.1 to about 3 wt % of the detergent composition.

In some instances, a twenty-fourth aspect of the disclosure can be described as a liquid detergent composition according to any one of the first through twenty-third aspects, wherein the liquid detergent composition further comprises sodium lauryl sulfate. In some instances, the sodium lauryl sulfate is in an amount ranging from about 2 to about 10 wt % of the detergent composition.

In some instances, a twenty-fifth aspect of the disclosure can be described as a liquid detergent composition according to any one of the first through twenty-fourth aspects, wherein the liquid detergent composition further comprises propylene glycol. In some instances, the propylene glycol is in an amount ranging from about 0.1 to about 5 wt % of the detergent composition.

In some instances, a twenty-sixth aspect of the disclosure can be described as a liquid detergent composition according to any one of the first through twenty-fifth aspects, wherein the liquid detergent composition further comprises ethanol. In some instances, the ethanol is in an amount ranging from about 0.1 to about 5 wt % of the detergent composition.

In some instances, a twenty-seventh aspect of the disclosure can be described as a liquid detergent composition according to any one of the first through twenty-sixth aspects, wherein the liquid detergent composition further comprises one or more of a defoamer, a buffer, an optical brightener, a chelating agent, an anti-redeposition polymer, and a preservative.

In some instances, a twenty-eighth aspect of the disclosure can be described as a liquid detergent composition according to the twenty-seventh aspect, wherein the combined amount of the one or more of the defoamer, the buffer, the optical brightener, the chelating agent, the anti-redeposition polymer, and the preservative is in an amount ranging from about 5 to about 25 wt % of the detergent composition.

In some instances, a twenty-ninth aspect of the disclosure can be described as a liquid detergent composition according to any one of the first through twenty-eighth aspects, wherein the pH of the liquid detergent composition ranges from about 7 to about 10.

In some instances, a thirtieth aspect of the disclosure can be described as a liquid detergent composition according to any one of the first through twenty-eighth aspects, wherein the pH of the liquid detergent composition ranges from about 10 to about 12.

In some instances, a thirty-first aspect of the disclosure can be described as a method of cleaning laundry comprising diluting a detergent composition according to any one of the first through thirtieth aspects, and cleaning the laundry using the diluted detergent composition.

In some instances, a thirty-second aspect of the disclosure can be described as a method of cleaning textiles comprising combining an amount of the detergent composition according to any one of the first through thirtieth aspects with an amount of water to form a diluted detergent composition having from about 1 gram to about 2 grams of the detergent composition per liter of water, and cleaning the textiles using the diluted detergent composition.

In some instances, a thirty-third aspect of the disclosure directed towards the thirty-first and thirty-second aspects, wherein the textiles are made of natural materials, synthetic materials or blends thereof.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

As used herein, the term “textile” means fibers, yarns, woven or unwoven fabrics, cloths and so on. The textiles may be made of natural materials, synthetic materials or blends thereof. Example natural materials include, but are not limited to, cotton, wool, cashmere, mohair, alpaca hair, silk, linen, jute, and cellulosic fibers. Example synthetic materials synthetic materials include, but are not limited to polyester (PES), polyethylene (PE), polypropylene (PP), polyurethane (PU), polystyrene (PS), polyvinyl chloride (PVC), polycarbonate (PC), polyamide (PA), polyphenylene ether, polyphenylene sulfide, polyoxymethylene (POM), polymethyl methacrylate (PMA), polyethylene terephthalate (PET), polybutylene terephthalate (PBT), polytetrafluoroethylene (PTFE), polyhydroxyalkanoate (PHA), polyhydroxybutyrate (PHB), polyimide (PI), polylactide (PLA), polyvinylidene fluoride (PVDF), polyetherketone (PEK), and/or copolymers or blends thereof. Blended textiles can be made of at least one natural material and at least one synthetic material. Blended textiles can have a natural material to synthetic material weight: weight ratio ranging from, for example 5:95 to 95:5, alternatively from 10:90 to 90:10, alternatively from 15:85 to 85:15, alternatively from 20:80 to 80:20, alternatively from 25:75 to 75:25, alternatively from 30:70 to 70:30, alternatively from 35:65 to 65:35, alternatively from 40:60 to 60:40, and alternatively from 45:55 to 55:45.

Various aspects of the disclosure are directed to liquid detergent compositions and methods of using the same. In accordance with various aspects of the disclosure, certain liquid detergent compositions comprise, consist essentially of, or consist of a peptide, an anionic surfactant, a non-ionic surfactant, and water. In accordance with various aspects of the disclosure, the inventors have discovered the use of certain peptide in laundry detergent compositions serves at least two important purposes. First, the inventors have discovered that certain peptides serve as effective chlorine scavengers when used in laundry detergent compositions. This is of importance since both wash and rinse water (especially water from municipal sources) contain chlorine as a sanitization agent against microbes. Chlorine deteriorates dyes in textiles over time, which may be observed (by, for example, reduced color saturation or intensity exhibited by the textile) in as little as 30 washes or less if not controlled. In addition to fabric dye damage, chlorine can negatively impact the cleaning performance of enzymes that may be present in laundry detergent compositions. Furthermore, the peptides can be engineered to adhere to the textile, so they can carry over to the rinse water and scavenge chlorine in the rinse water. This will provide a color care benefit, since scent boosters/detergents added to the wash will only scavenge chlorine in the wash water, leaving textiles susceptible to chlorine in the rinse water. Products such as fabric softeners (containing ester quats) will scavenge chlorine in the rinse water (since they are added to the rinse water), but not all consumers use fabric softeners. The use of a specialized peptide will provide the consumer with the benefit of scavenging chlorine in both wash and rinse water, providing better color care to their textiles. As such, the use of peptides as a chlorine scavenger and textile binder can help enhance enzyme cleaning performance and thus the overall cleaning efficiency of the laundry detergent composition through its use.

Liquid detergent compositions according to the disclosure include a peptide that has the ability to adhere to a textile and includes amino acids susceptible to oxidation in the presence of, for example, chlorine as described elsewhere herein. Peptides for use in liquid detergents according to the disclosure can range from about 5 to about 200 amino acids in length. In some instances, the peptide can range from about 5 to about 100 amino acids in length. In some instances, the peptide can range from about 5 to about 75 amino acids in length. In some instances, the peptide can range from about 5 to about 70 amino acids in length. In some instances, the peptide can range from about 10 to about 60 amino acids in length.

In some instances, laundry detergent compositions according to the disclosure comprise a peptide, wherein the peptide is at least 80% of one of SEQ ID NO: 1-6. In some instances, the peptide is at least 85% of one of SEQ ID NO: 1-6. In some instances, the peptide is at least 90% of one of SEQ ID NO: 1-6. SEQ ID NO: 1-6 are provided in Table 6 below.

In some instances, laundry detergent compositions according to the disclosure comprises a peptide, wherein the peptide is at least 80% of one of SEQ ID NO: 7-12. In some instances, the peptide is at least 85% of one of SEQ ID NO: 7-12. In some instances, the peptide is at least 90% of one of SEQ ID NO: 7-12. SEQ ID NO: 7-12 are provided in Table 6 below.

In some instances, peptides for use in liquid detergents according to the disclosure can further comprise a linking domain. In some instances, the peptides comprise more than one linking domain. In some instances, a linking domain according to the disclosure includes an amino acid sequence of at least five amino acids. In some instances, linking domains comprise, consist essentially of, or consist of a GGGGS sequence (SEQ ID NO: 13) and/or an EAAAK sequence (SEQ ID NO: 19). Exemplary linking domains include, but are not limited to, SEQ ID NO: 13-24, provided in Table 6 below. In some instances, at least one linking domain of the peptide is at least 80% of one of SEQ ID NO: 13-24. In some instances, at least one linking domain of the peptide is at least 85% of one of SEQ ID NO: 13-24. In some instances, at least one linking domain of the peptide is at least 90% of one of SEQ ID NO: 13-24.

Peptides for use in liquid detergents according to the disclosure have individual amino acids incorporated therein that are susceptible to oxidation. In some instances, the individual amino acids susceptible to oxidation comprise about 1 to about 75% of the peptide, relative to the total number of amino acids in the peptide. In some instances, the individual amino acids susceptible to oxidation comprise about 1 to about 50% of the peptide, relative to the total number of amino acids in the peptide. In some instances, the individual amino acids susceptible to oxidation comprises about 1.5 to about 45% of the peptide, relative to the total number of amino acids in the peptide. In some instances, the individual amino acids susceptible to oxidation comprises about 2 to about 40% of the peptide, relative to the total number of amino acids in the peptide. In some instances, the individual amino acids susceptible to oxidation comprises about 2.5 to about 35% of the peptide, relative to the total number of amino acids in the peptide. In some instances, the amino acids susceptible to oxidation comprises about 3% to about 30% of the peptide, relative to the total number of amino acids in the peptide. In some instances, the individual amino acids susceptible to oxidation comprises about 3.3% to about 25% of the peptide, relative to the total number of amino acids in the peptide. One of ordinary skill in the art will appreciate that alanine, arginine, asparagine, aspartic acid, cysteine, glutamine, glutamic acid, glycine, histidine, isoleucine, lysine, methionine, phenylalanine, proline, serine, threonine, tryptophan, tyrosine, and valine are all susceptible to oxidation in varying degrees. In accordance with various aspect of the disclosure, peptides including one or more of cysteine, methionine, lysine, histidine, and arginine as individual amino acids susceptible to oxidation are preferred. In some instances, there is at least two individual amino acids susceptible to oxidation within the peptide. In some instances, there are at least three amino acids susceptible to oxidation within the peptide. In some instances, there are at least four individual amino acids susceptible to oxidation within the peptide. In some instances, there are up to 10, alternatively up to 10, alternatively up to 30 individuals, alternatively up to 40 individuals, and alternatively up to 50 individual amino acids susceptible to oxidation within the peptide. In some instances, the amount of aminos acids susceptible to oxidation within the peptides ranges from about 2 to about 80 amino acids.

Peptides for use in liquid detergents according to the disclosure include one or more domains having amino acids that exhibit a binding affinity to textiles. In some instances, the amino acids that bind to textiles are leucine, glycine, alanine, serine, arginine, isoleucine, glutamine, and proline. In some instances, some amino acids can be both susceptible to oxidation and prone to textile binding. In some instances, the amino acids exhibiting textile binding affinity comprise about 1 to about 75% of the peptide, relative to the total number of amino acids in the peptide. In some instances, the amino acids exhibiting textile binding affinity comprise about 1 to about 50% of the peptide, relative to the total number of amino acids in the peptide. In some instances, the amino acids exhibiting textile binding affinity comprise about 1.5 to about 45% of the peptide, relative to the total number of amino acids in the peptide. In some instances, the amino acids exhibiting textile binding affinity comprise about 2 to about 40% of the peptide, relative to the total number of amino acids in the peptide. In some instances, the amino acids exhibiting textile binding affinity comprise about 2.5 to about 35% of the peptide, relative to the total number of amino acids in the peptide. In some instances, the amino acids exhibiting textile binding affinity comprise about 3% to about 30% of the peptide, relative to the total number of amino acids in the peptide, relative to the total number of amino acids in the peptide. In some instances, the amino acids exhibiting textile binding affinity comprise about 3.3% to about 25% of the peptide, relative to the total number of amino acids in the peptide. In some instances, there is one amino acid capable of binding to textiles within the peptide. In some instances, peptides according to various aspects of the disclosure, that is peptides having one of more domains with amino acids that exhibit a binding affinity to textiles, exhibit a 10-fold, or in some instances, 20-fold, 50-fold, or 100-fold higher incidence of adhesion to a given textile than alternatives peptides of comparable length without domains exhibit textile binding affinity.

In some instances, one or more amino acids in the peptide can be both susceptible to oxidation and prone to binding to a textile. In some instances, an amino acid that is both susceptible to oxidation and prone to binding to a textile is arginine. In some instances, amino acids that do not have a primary amine group after forming a peptide bond can make up less than 90% of a binding domain of the one or more binding domains. In some instances, amino acids that do not have a primary amine group after forming a peptide bond can make up less than 80% of a binding domain of the one or more binding domains. In some instances, amino acids that do not have a primary amine group after forming a peptide bond can make up less than 70% of a binding domain of the one or more binding domains. In some instances, amino acids that do not have a primary amine group after forming the peptide bond can make up less than 60%, 50%, 40%, 30%, 20%, or 10% of a binding domain of the one or more binding domains.

In some instances, each amino acid susceptible to oxidation is no more than one amino acid away from an amino acid exhibiting textile binding affinity in the peptide. In some instances, each amino acid susceptible to oxidation is no more than two amino acids away from an amino acid exhibiting textile binding affinity in the peptide. In some instances, each amino acid susceptible to oxidation is no more than 3, 4, 5, 6, 7, 8, 9, 10, 11, 12, 13, 14, 15, 16, 17, 18, 19, or 20 amino acids away from an amino acid exhibiting textile binding affinity in the peptide. In some instances, a linking domain as described elsewhere herein is located between amino acids susceptible to oxidation and amino acids exhibiting textile binding affinity.

Peptides according to various aspects of the disclosure may be chemically synthesized and/or recombinantly produced by protein design. Short peptides can be easily reproduced synthetically (for example, via solid-phase synthesis such as Merrifield's solid-phase synthesis). Longer peptides and polypeptides, on the other hand, are often produced recombinantly in a host organism. In some instances, it may be preferable to produce peptides according to the disclosure by means of recombinant processes. This is to be understood as any genetic engineering or microbiological process that is based on the introduction of the genes for the peptides of interest into a host organism suitable for production and transcribed and translated by it. Using common methodologies, such as chemical synthesis or polymerase chain reaction (PCR) in conjunction with standard molecular biological and/or protein chemical methods, it is possible to produce the corresponding nucleic acids up to complete genes on the basis of known DNA and/or amino acid sequences. Such methods are known in the art (for example, see Sambrook, J., Fritsch, E. F. and Maniatis, T. 2001. Molecular cloning: a laboratory manual, 3rd edition Cold Spring Laboratory Press.”

Peptides according to various aspects of the disclosure may exhibit amino acid changes, in particular amino acid substitutions, insertions or deletions. Such peptides have been further developed by, for example, targeted genetic modification (such as by mutagenesis methods) and optimized for specific applications or with regard to special properties (for example, with regard to their stability, binding, etc.).

For example, targeted mutations such as substitutions, insertions or deletions can be introduced into the known molecules in order to change certain properties. For this purpose, the surface charges and/or the isoelectric point of the molecules and thus their interactions with a surface can be changed. For example, the net charge of the peptides can be changed in order to influence the substrate binding. Alternatively, or additionally, one or more corresponding mutations can increase the stability or adsorption of the peptide, for example. Advantageous properties of individual mutations (for example, individual substitutions) can complement each other.

Thus, various aspects of the disclosure are directed to peptides characterized by the fact that they are available from a peptide as a starting molecule as described above (for example, from a molecule with one of the amino acid sequences according to SEQ ID NO:1-6) on which one or more amino acid substitutions, including one or more conservative amino acid substitutions, have been performed, wherein the resulting peptide is at least 80% and increasingly preferably at least 81%, 82%, 83%, 84%, 85%, 86%, 87%, 88%, 89%, 90%, 91%, 92%, 93%, 94%, 95%, 96%, 97%, 98%, 99% and less than 100% sequence identity with any of the amino acid sequences according to SEQ ID NO:1-6.

Thus, various aspects of the disclosure are also directed to peptides characterized by the fact that they are available from a peptide as a starting molecule as described above (for example, from a molecule with one of the amino acid sequences according to SEQ ID NO:7-12) on which. one or more amino acid substitutions, including one or more conservative amino acid substitutions, have been performed, wherein the resulting peptide is at least 80% and increasingly preferably at least 81%, 82%, 83%, 84%, 85%, 86%, 87%, 88%, 89%, 90%, 91%, 92%, 93%, 94%, 95%, 96%, 97%, 98%, 99% and less than 100% sequence identity with any of the amino acid sequences according to SEQ ID NO:7-12.

The term “conservative amino acid substitution” means the substitution of an amino acid residue for another amino acid residue, whereby this exchange does not result in a change in polarity or charge at the position of the exchanged amino acid, e.g., the exchange of a non-polar amino acid residue for another non-polar amino acid residue. Conservative amino acid substitutions according to various aspects of the disclosure include, for example: G=A=S, I=V=L=M, D=E, N=Q, K=R, Y=F, S=T, G=A=I=V=L=M=Y=F=W=P=S=T. However, in some instances, it may be preferable that such exchanges do not have glycine or tyrosine as the target amino acid, or no amino acid that has a low alpha-helix-forming potential.

In some preferred embodiments, peptides according various aspects of the disclosure may also be modified. In some instances, preferred modifications include, for example, coupling the peptide with certain other molecules or chemical groups (such as, for example organic (macro) molecules) via, for example a covalent bond or a linker/spacer via a suitable amino acid of the chain and/or N- and/or C-terminal.

All of the above features can be realized individually or in any combination.

Furthermore, the peptide of the invention can also be at least a subunit (module) of a larger peptide or polypeptide, wherein the polypeptide may comprise a multimer of the sequences described herein, such as 1 to 30 repeats, preferably 2 to 15 repetitions, especially preferably 2 to 10 repetitions (for example, 2, 3, 4, 5 or 6 repetitions of the peptide. The polypeptide may include or consist of such multimers. In this context, the term “polypeptide” refers in particular to peptides that comprise 100 or more amino acids. The term “larger peptides” refers to peptides with at least 40 amino acids, unless otherwise described.

In some instances, the peptide is a peptide or polypeptide (multimer) comprising two or more of the peptides as described herein. In some instances, the two or more peptides may be connected to each other by at least one spacer. In some instances, the at least one spacer preferably comprises or consists of 1 to 10 amino acid residues (in some instances, particularly 2, 3 or 4 amino acid residues) preferably selected from the group consisting of G, P, I, A and S or combinations thereof, in particular GPI or GAS. In such instances, the individual peptides are optionally linearly connected to each other via peptide bonds, and possibly also via a spacer.

The peptides described herein may have been chemically synthesized and/or recombinantly produced by protein design in various embodiments. Nowadays, short peptides can be easily reproduced synthetically (via, for example, solid-phase synthesis such as Merrifield's solid-phase synthesis). Longer peptides and polypeptides, on the other hand, are often produced recombinantly in the host organism (for example, bacteria or yeasts).

It is preferable to produce peptides and/or peptide conjugates according to various aspects of the disclosure by means of recombinant processes. This is to be understood as any genetic engineering or microbiological process that is based on the introduction of the genes for the peptides of interest into a host organism suitable for production and transcribed and translated by it (summarized in the context of this invention as biotechnological processes).

In particular, the peptides and/or peptide conjugates according to the invention are produced as polypeptides (multimers) and subsequently cleaved into the functional peptides and/or peptide conjugates. Particularly preferred multimers have 1 to 30 peptide units (each according to the invention), each separated from each other by spacers of 1 to 10 amino acids in length (for example, 1, 2, 3 or 4 amino acids). Alternatively, the spacers can also be or include interfaces for specific proteases/peptidases, in particular endopeptidases, or form such an interface together with parts of the peptide.

Using methods commonly known today, such as chemical synthesis or polymerase chain reaction (PCR) in conjunction with standard molecular biological and/or protein chemical methods, it is possible for an expert to produce the corresponding nucleic acids up to complete genes on the basis of known DNA and/or amino acid sequences. Such methods are known, for example, from Sambrook, J., Fritsch, E. F. and Maniatis, T. 2001. Molecular cloning: a laboratory manual, 3rd edition Cold Spring Laboratory Press.

In some instances, production of the peptides and/or peptide conjugates described herein by biotechnological processes, as described above, may be preferred.

In some instances, a peptide according to the various aspects of disclosure can be present in an amount ranging from about 0.01 to about 1.5 wt % of a liquid detergent composition according to various aspects of the disclosure. In some instances, a peptide according to the disclosure can be in an amount ranging from about 0.01 to about 5 wt %, alternatively from about 0.025 to about 4.5 wt %, alternatively from about 0.05 to about 4 wt %, alternatively from about 0.075 to about 3.5 wt %, alternatively from about 0.1 to about 3 wt %, alternatively from about 0.12 to about 2.5 wt %, alternatively from about 0.13 to about 2 wt %, alternatively from about 0.14 to about 1.5 wt %, and alternatively from about 0.15 to about 1 wt % of a liquid detergent composition according to the disclosure.

In some instances, an anionic surfactant can be present in an amount ranging from about 5 to about 35 wt % of a liquid detergent composition according to various aspects of the disclosure. In some instances, the anionic surfactant can be present in an amount ranging from about 1 to about 35 wt % of a liquid detergent composition according to various aspects of the disclosure. In some instances, the anionic surfactant is in an amount from 1 wt % up to 5, 7.5, 10, 12.5, 15, 17.5, 20, 22.5, 25, 27.5, 30, 32.5, or 35 wt % of a liquid detergent composition according to the disclosure. Various classes of anionic surfactants may be used. In some instances, the anionic surfactant is a linear alkyl sulfonate (LAS) or a linear alkylbenzene sulfonate (LABS). LAS and LABS are water soluble salts between 8 and 22 carbon atoms in the alkyl group. In some instances, suitable LAS and/or LABS compounds may include salts of C₈-C₁₈ alkyl sulfonic acids and salts of C₈-C₁₈ alkylbenzyl sulfonic acids. Suitable in some instances, the anionic surfactant is a linear alkyl ether (or laureth) sulfonate. In some instances, suitable linear alkyl ether sulfonates include a linear C₈-C₁₈ alkyl chain, 4-9 repeating ethylene oxide units, and an anionic head group made up of the sulfonate group and a counter cation. Suitable counter cations for LAS, LABS and linear alkyl ether sulfonates include, but are not necessarily limited to, Na⁺, K⁺, and NH₄⁺. In some instances, the anionic surfactant is sodium or potassium lauryl sulfate or a sodium or potassium lauryl ether sulfate.

In some instances, a nonionic surfactant can be present in an amount ranging from about 5 to about 30 wt % of a liquid detergent composition according to various aspects of the disclosure. In some instances, a nonionic surfactant can be present in an amount ranging from about 1 to about 30 wt % of a liquid detergent composition according to various aspects of the disclosure. In some instances, the nonionic surfactant is in an amount ranging from about 7.5 to about 25 wt %, alternatively from about 10 to about 20 wt %, alternatively from about 15 to about 20 wt %, and alternatively from about 16 to about 18 wt % of a liquid detergent composition according to the disclosure. In some instances, the nonionic surfactant and anionic surfactant is in an amount ranging from about 1 to about 50 wt %, alternatively from about 1.5 to about 45 wt %, and alternatively from about 2.5 to about 40 wt % a liquid detergent composition according to the disclosure.

Various nonionic surfactants may be used. Exemplary nonionic surfactants include, but are not limited to, alkoxylated alcohols, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, or any combinations thereof.

In some instances, a combined amount of nonionic surfactant and anionic surfactant in liquid detergent compositions according to various aspects of the disclosure can be in an amount ranging from about 5 to about 22.5 wt %, alternatively from about 10 to about 20 wt %, alternatively from about 15 to about 20 wt %, and alternatively from about 16 to about 18 wt %. In some instances, the combined amount of nonionic surfactant and anionic surfactant in liquid detergent compositions according to various aspects of the disclosure can be in an amount ranging from about 1 to about 70 wt %, alternatively about 1 to about 60 wt %, alternatively 1 to about 50 wt %, alternatively from about 1.5 to about 45 wt %, alternatively from about 2 to about 40 wt %, alternatively from about 2.5 to about 35 wt %, and alternatively from about 3 to about 35 wt %. In some instances, liquid detergent compositions according to various aspects of the disclosure have a nonionic surfactant to anionic surfactant ration ranging from about 5:1 to about 1:5. In some instances, the ratio of nonionic surfactants to anionic surfactant can range from about 4:1 to about 1:4, alternatively from about 3:1 to about 1:3, alternatively from about 2:1 to about 1:2, alternatively from about 1.5:1 to about 1:1.5, and alternatively about 1:1. In some instances, the ratio of nonionic surfactants to anionic surfactant can range from about 10:1 to about 1:10, alternatively from about 9:1 to about 1:9, alternatively from about 8:1 to about 1:8, alternatively from about 7:1 to about 1:7, and alternatively from about 6:1 to about 1:6.

Detergent compositions according to various aspects of the disclosure can have pH values ranging from about 5 to 12, alternatively from about 5.5 to about 12, alternatively, alternatively from about 6 to about 12, alternatively from about 6.5 to about 12, alternatively from about 9 to about 12, alternatively from about 7 to about 10, alternatively from about 10 to about 12, alternatively from about 7 to about 12, and alternatively from about 7 to about 11.5. For example, when such detergent compositions include one or more enzymes, as discussed further below, the pH value may optimally range from about 7 to about 9 to promote stability of the one or more enzymes. Also, for example, detergent compositions do not contain enzymes can have a pH as high as about 10, alternatively as high as about 10.5, alternatively as high as about 11, and alternatively as high as about 11.5.

In some instances, detergent compositions according to various aspects of the disclosures may exhibit a pH ranging from about 9 to about 12, a zein score of less than about 2%, or both. In some instances, the pH of such detergent compositions can range from about 7 to about 12. In some instances, the pH of such detergent compositions can range from about 8 to about 12. In some instances, the pH of such detergent compositions can range from about 10 to about 12.

In some instances, detergent compositions according to various aspects of the disclosure may further comprise a suitable tetraborate salt such as, for example, sodium tetraborate. In some instances, a suitable tetraborate salt can be present in an amount ranging from about 0.1 to about 1.0 wt % of a detergent composition. In some instances, a suitable tetraborate salt can be present in an amount ranging from about 0.01 to about 2.0 wt %, alternatively from about 0.025 to about 1.75 wt %, alternatively from about 0.05 to about 1.5 wt %, and alternatively from about 0.075 to about 1.25 wt % of a detergent composition. In some instances, the tetraborate salt is in an amount of about 0.1, 0.2, 0.3, 0.4, 0.5, 0.6, 0.7, 0.8, 0.9, or 1.0 wt % of a detergent composition. In some instances, the tetraborate salt is in an amount ranging from about 0.1 to about 3 wt % of the detergent composition.

In some instances, detergent compositions according to various aspects of the disclosure may further comprise a strong base. In some instances, the strong base is in an amount ranging from about 0.5 to about 5 wt % of the detergent composition. In some instances, the amount of the strong base is about 2.4 wt % of the detergent composition. In some instances, the strong base is in an amount ranging from about 0.1 to about 10 wt % of the detergent composition. In some instances, the strong base can be, for example, potassium hydroxide, sodium hydroxide, or calcium hydroxide. Generally, any amount of strong base may be added to a detergent composition to provide said detergent composition with a target end property such as, for example, pH.

In some instances, detergent compositions according to various aspects of the disclosure may further comprise a weak acid. In some instances, the weak acid is in an amount ranging from about 0.5 to about 6.0 wt % of the detergent composition. In some instances, the weak acid can be in an amount ranging from about 1 to about 9 wt % of the detergent composition. In some instances, the weak acid can be, for example, citric acid, acetic acid, lactic acid, stearic acid, palmitic acid, or oleic acid. Generally, any amount of weak acid may be added to a detergent composition to provide said detergent composition with a target end property such as, for example, pH.

In some instances, detergent compositions according to various aspects of the disclosure may include both a strong acid and a weak acid as described above. Generally, any amount of weak acid or strong base may be added to a detergent composition to provide said detergent composition with a target end property such as, for example, pH.

In some instances, detergent compositions according to various aspects of the disclosure may include a fatty acid. In some instances, the fatty acid is in an amount ranging from about 0.1 to about 1 wt % of the detergent composition. In some instances, the fatty acid is in an amount ranging from about 0.1 to about 3 wt % of the detergent composition. In some instances, the fatty acid is a coconut fatty acid. In some instances, the fatty acid may be one or more of lauric, myristic, palmitic, stearic, ricinoleic, oleic, linoleic, or linolenic acids.

In some instances, detergent compositions according to various aspects of the disclosure may include an aqueous enzyme solution comprising a cocktail of one or more enzymes. In some instances, the one or more enzymes may include, for example, one or more of an amylase, a protease, and a mannanase. In some instances, the aqueous enzyme solution is in an amount ranging from about 1 to about 3 wt % of the detergent composition. In some instances, the aqueous enzyme solution is in an amount ranging from about 0.5 to about 5 wt % of the detergent composition. In some instances, the aqueous enzyme solution is in an amount ranging from 0.5 to 2.5 wt % of the detergent composition. In some instances, the aqueous enzyme solution is in an amount ranging from about 0.1 to about 5 wt % of the detergent composition.

In some instances, detergent compositions according to various aspects of the disclosure may include a chelating agent. In some instances, the chelating agent is in an amount ranging from about 1 to about 5 wt % of the detergent composition. In some instances, the chelating agent is in an amount ranging from about 0.1 to about 3 wt % of the detergent composition. In some instances, the chelating agent is in an amount ranging from about 0.1 to about 5 wt % of the detergent composition. In some instances, the chelating agent is N,N-bis(carboxymethyl)-L-glutamic acid tetrasodium salt. Chelating agents are sometimes used as water softeners in detergent compositions. In some instances, the chelating agent is iminodisuccinate (IDS), ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, ethylenediamine-N,N′-disuccinic acid (EDDS), hydroxyethylenediaminetriacetic acid (HEDTA), N,N-bis(carboxymethyl)-L-glutamic acid tetrasodium salt, alanine, N,N-bis(carboxymethyl)-alanine, trisodium salt or other chelating compounds.

In some instances, detergent compositions according to various aspects of the disclosure may include a preservative. In some instances, the preservative is in an amount ranging from about 0.05 to about 2 wt % of the detergent composition. In some instances, the preservative is in an amount ranging from about 0.01 to about 2 wt % of the detergent composition. In some instances, the preservative is one or more of a microbiocide, an algicide, and a fungicide. In some instances, the preservative is a mixture of 5-chloro-2-methyl-2H-isothiazol-3-one and 2-methylisothiazol-3(2H)-one and 1,2-benzisothiazol-3(2H)-one. In some instances, preservative is methylisothiazolinone, chloromethylisothiazolinone, benzisothiazolinone, sorbic acid, sodium benzoate, formaldehyde, borate, and glutaraldehyde. In some instances, detergent compositions according to various aspects of the disclosure may be free of, or substantially free of, preservatives.

In some instances, detergent compositions according to various aspects of the disclosure may include an anti-redeposition polymer. In some instances, anti-redeposition agents include polymers with a soil detachment capacity, which are also known as “soil repellents” due to their ability to provide a soil-repelling finish on the treated surface, such as a fiber. In some instances, the anti-redeposition polymer is in an amount ranging from about 0.1 to about 1 wt % of the detergent composition. In some instances, the anti-redeposition polymer is an acrylic/styrene copolymer. In some instances, the polymer can be a polyester. In some instances, the polyesters include co-polyesters prepared from dicarboxylic acids, such as adipic acid, phthalic acid or terephthalic acid. In some instances, an anti-redeposition agents includes polyesters with a soil detachment capacity that include those compounds which, in formal terms, are obtainable by esterifying two monomer moieties, the first monomer being a dicarboxylic acid HOOC—Ph—COOH and the second monomer a diol HO—(CHR—)ₐOH, which may also be present as a polymeric diol H—(O—(CHR—)ₐ)_{b}OH. “Ph” here means an ortho-, meta- or para-phenylene residue that may bear 1 to 4 substituents selected from alkyl residues with 1 to 22 C atoms, sulfonic acid groups, carboxyl groups and mixtures thereof, “R” means hydrogen or an alkyl residue with 1 to 22 C atoms and mixtures thereof, “a” means a number from 2 to 6 and “b” means a number from 1 to 300. In some instances, the polyesters obtainable therefrom may contain not only monomer diol units —O—(CHR—)ₐO— but also polymer dial units —(O—(CHR—)ₐ)_{b}O—. In some instances, the molar ratio of monomer diol units to polymer diol units may amount to from about 100:1 to about 1:100, or alternatively from about 10:1 to about 1:10. In some instances, the polymer diol units, the degree of polymerization “b” may be in the range of from about 4 to about 200, or alternatively from about 12 to about 140. In some instances, the number average molecular weight of the polyesters with a soil detachment capacity may be in the range of from about 250 to about 100,000, or alternatively from about 500 to about 50,000. In some instances, the acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid and mixtures thereof. In some instances, the acid groups thereof are not part of the ester bond in the polymer, they may be present in salt form, such as an alkali metal or ammonium salt.

In some instances, instead of the monomer HOOC—Ph—COOH, polyesters with a soil detachment capacity (the anti-redeposition agent) may include small proportions, for example up to about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR—)ₐOH include those in which Ris hydrogen and “a” is a number of from about 2 to about 6, and in some instances those in which “a” has the value of 2 and Ris selected from hydrogen and alkyl residues with 1 to 10 C atoms, or where Ris selected from hydrogen and alkyl residues with 1 to 3 C atoms in another embodiment. Examples of diol components include ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. The polymeric diols may include polyethylene glycol with an average molar mass in the range from about 1000 to about 6000. In some instances, these polyesters may also be end group-terminated, with end groups that may be alkyl groups with 1 to 22 C atoms or esters of monocarboxylic acids. The end groups attached via ester bonds may be based on alkyl, alkenyl and aryl monocarboxylic acids with 5 to 32 C atoms, or alternatively with 5 to 18 C atoms. These may include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, which may bear 1 to 5 substituents having a total of up to 25 C atoms, or alternatively 1 to 12 C atoms, for example tert-butylbenzoic acid. The end groups may also be based on hydroxymonocarboxylic acids with 5 to 22 C atoms, which for example include hydroxyvaleric acid, hydroxycaproic acid, ricinoleic acid, the hydrogenation product thereof, hydroxystearic acid, and ortho-, meta- and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e., their degree of oligomerization, may be in the range of from 1 to 50, or alternatively in the range of from 1 to 10. In some instances, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, can be used alone or in combination with cellulose derivatives. In some instances, the anti-redeposition polymer is in an amount ranging from about 0.1 to about 3 wt % of the detergent composition. In some instances, the anti-redeposition polymer is in an amount ranging from about 0.1 to about 10 wt % of the detergent composition.

In some instances, detergent compositions according to various aspects of the disclosure may include an optical brightener. Optical brighteners adsorb ultraviolet and/or violet light and re-transmit it as visible light, typically a visible blue light. Optical brighteners include, but are not limited to, derivatives of diaminostilbene disulfonic acid or alkali metal salts thereof. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-stated optical brighteners may also be used. In some instances, optical brighteners may be present in detergent compositions in an amount ranging about 0.01 to about 0.5 wt %, alternatively from about 0.01 to about 1 wt %, alternatively from about 0.01 to about 3 wt %, or alternatively from 0.01 to about 5 wt % of the detergent composition.

In some instances, detergent compositions according to various aspects of the disclosure may include one or more foam inhibitors (i.e., defoamers). In some instances, foam inhibitors include, but are not limited to, fatty acids such as coconut fatty acids. In some instances, suitable foam inhibitors include, for example, soaps of natural or synthetic origin (which may exhibit elevated proportions of C₁₈-C₂₄ fatty acids), organopolysiloxanes and mixtures thereof with microfine (and optionally silanized) silica, paraffins, waxes, microcrystalline waxes, and mixtures thereof with silanized silica or bis-fatty acid alkylenediamides (for example, bistearylethylenediamide), silicones, and combinations thereof. In some instances, foam inhibitors may be present in detergent compositions in an amount ranging about 0.01 to about 0.5 wt %, alternatively from about 0.01 to about 0.1 wt %, alternatively from about 0.01 to about 3 wt %, or alternatively from 0.01 to about 5 wt % of the detergent composition.

In some instances, detergent compositions according to various aspects of the disclosure may include bittering agents to hinder accidental ingestion of the composition. Bittering agents are compositions that taste bad, so children or others are discouraged from accidental ingestion. In some instances, the bittering agent is denatonium benzoate, aloin, or others. Bittering agents may be present in the composition in an amount ranging about 0.01 to about 0.5 wt %, alternatively from about 0.01 to about 0.1 wt %, alternatively from about 0.01 to about 3 wt %, or alternatively from 0.01 to about 5 wt % of the detergent composition.

In some instances, detergent compositions according to various aspects of the disclosure may include sodium sulfite. Sodium sulfite is an oxygen scavenger, where sodium sulfite reacts with oxygen to form sodium sulfate. Free oxygen, such as oxygen dissolved in the wash composition, can react to produce metal oxides (rust) that reduce the life of the washing equipment. The metal oxides can also stain garments, dishes, or other items being washed. Dissolved oxygen can also react to produce other components, and some of those components may be colored bodies. Therefore, the sodium sulfite can help reduce the formation of colored bodies in the wash composition. However, sodium sulfite includes sodium, and sodium-containing compounds tend to produce efflorescent solids in the film. In some instances, the sodium sulfite is present in the wash composition at a concentration of from about 0.05 to about 4 wt %, or from about 0.05 to about 3 wt %, or from about 0.05 to about 2 wt %, all based on the total weight of the detergent composition.

In some instances, detergent compositions according to various aspects of the disclosure may include a linear alkyl benzene sulfonic acid. In some instances, the linear alkyl benzene sulfonic acid is in an amount ranging from about 3 to about 15 wt % of the detergent composition. In some instances, the linear alkyl benzene sulfonic acid is in an amount ranging from about 5 to about 10 wt % of the detergent composition.

In some instances, detergent compositions according to various aspects of the disclosure may include a sodium lauryl sulfate. In some instances, the sodium lauryl sulfate is in an amount ranging from about 1 to about 15 wt % of the detergent composition. In some instances, the sodium lauryl sulfate is in an amount ranging from about 2 to about 10 wt % of the detergent composition.

In some instances, detergent compositions according to various aspects of the disclosure may include one or more a microbiocide, an algicide, and a fungicide. In some instances, the one or more of the microbiocide, the algicide, and the fungicide are in in an amount ranging from about 0.01 to about 5 wt % of the detergent composition. In some instances, the microbiocide, algicide, and fungicide are in an amount ranging from about 0.01 to about 3 wt % of the detergent composition.

In some instances, detergent compositions according to various aspects of the disclosure may include propylene glycol. In some instances, the propylene glycol is in an amount ranging from about 1 to about 10 wt % of the detergent composition. In some instances, the propylene glycol is in an amount ranging from about 2.5 to about 7.5 wt % of the detergent composition. In some instances, the propylene glycol is in an amount ranging from about 0.1 to about 5 wt % of the detergent composition. In some instances, the propylene glycol is in an amount of about 5 wt % of the detergent composition.

In some instances, detergent compositions according to various aspects of the disclosure may include ethanol. In some instances, the ethanol is in an amount ranging from about 1 to about 10 wt % of the detergent composition. In some instances, the ethanol is in an amount ranging from about 2.5 to about 7.5 wt % of the detergent composition. In some instances, the ethanol is in an amount ranging from about 0.1 to about 5 wt % of the detergent composition. In some instances, the ethanol is in an amount ranging from about 0.1 to about 10 wt % of the detergent composition. In some instances, the ethanol is in an amount of about 5 wt % of the detergent composition.

In some instances, detergent compositions according to various aspects of the disclosure may include a combination of two or more of, or all of, a defoamer, a buffer, an optical brightener, an anti-redeposition polymer, and a preservative. In some instances, the combined amount of two or more of, or all of, the defoamer, a buffer, the optical brightener, the anti-redeposition polymer, and the preservative ranges from about 5 to about 15 wt % of the detergent composition. In some instances, the buffer is a carbonate or bicarbonate. In some instances, an example of a suitable bicarbonate buffer is sodium bicarbonate. In some instances, the buffer is a borate. In some instances, the buffer is monoethanolamine. In some instances, the buffer is lysine. In some instances, the buffer is a sugar amine. In some instances, an example of a suitable sugar amine buffer is glucosamine. In some instances, the buffer is a citrate.

Also provided herein are methods of cleaning laundry. Methods of cleaning laundry may include combining an amount of a detergent composition according to various aspects of the disclosure with an amount of water to form a diluted detergent composition having from about 0.1 grams to about 1 gram of the detergent composition per liter of water and cleaning the laundry using the diluted detergent composition. In some instances the diluted detergent composition has a concentration of about 0.01 to about 10 grams, alternatively from about 0.02 to about 8 grams, alternatively from about 0.03 to about 6 grams, alternatively from about 0.04 to about 6 grams, alternatively from about 0.05 to about 5 grams, alternatively from about 0.06 to about 4 grams, alternatively from about 0.07 to about 3 grams, alternatively from about 0.08 to about 2 grams, and alternatively from about 0.09 to about 1.5 grams of the detergent composition per liter of water.

As used herein the phrase “Zein score” refers the measurement obtained from the Zein test as described herein. It can also be referred to as “Zein solubilized %.” In some instances, detergent compositions described herein have a Zein score of less than about 3% when tested as a 10% dilution. In certain instances, detergent compositions described herein have a Zein score of from about 0.01% to about 3%, alternatively from about 0.01% to about 2.75%, alternatively from about 0.01% to about 2.5%, alternatively from about 0.01% to about 2.25%, alternatively from about 0.01% to about 2%, alternatively from about 0.01% to about 1.75%, alternatively from about 0.01% to about 1.5%, alternatively from about 0.01% to about 1.25%, and alternatively from about 0.01% to about 1% when tested as a 10% dilution. In other instances, detergent compositions described herein can have a Zein score of less than about 2.75%, preferably less than about 2.5%, more preferably less than about 2.25%, even more preferably less than about 2%, even more preferably less than 1.75%, even more preferably less than about 1.5%, even more preferably less than about 1.25%, and even more preferably less than about 1% when tested as a 10% dilution.

In some instances, detergent compositions described herein have a Zein score less than 0.5%. In some instances, detergent compositions described herein have a Zein score ranging from about 0.3 to about 0.4%. The Zein score is used in these instances as a measurement of how mild the laundry detergent is as explained in the examples.

One method to test the skin irritancy potential of a surfactant composition is the Zein test. A Zein score is measured using a Zein test (Gott, E., Aesthet. Medzin. Tenside, 15:313 (1966)). The Zein test determines the extent of denaturation of Zein corn protein after exposure to a surfactant for a given period of time. Generally, the higher the Zein score, the greater the skin irritation potential.

Another method to measure the skin irritancy potential is corneosurfametry (CSM) test, a noninvasive quantitative test that measures the interaction between surfactants and human stratum corneum (Pierard et al., Dermatology 189:152-156 (1994)). Corneosurfametry involves removing a few layers of skin using cyanoacrylate skin surface strippings, short contact time with surfactants followed by staining the samples with fuchsian dyes. A less damaged barrier allows greater penetration of the stain, therefore giving a more intense color, which is measured using colorimetrically with L*a*b*color space. This method is predictive of both protein and lipid damage in the skin. CIM (Color Indicator of Mildness) values are obtained from a corneosurfametry test. In a comparative study, the higher the CIM value, the milder the surfactant formulation.

A third method to evaluate the irritation effect of a surfactant formulation is measured by cytokine release of representative human skin model in response to the surfactant formulation. Where skin tissue viability is not decreased by 50% as compared to the negative control tissue (as measured by MTT reduction), the inflammatory potential is then measured by the production of the cytokines IL-1a. and/or IL-1ra. MTT is a dye used to stain the skin cells called 3-(4, 5-dimethylthiazol-2-yl)-2, 5-diphenyltetrazolium bromide. In a comparative study, a lower cytokine release value means a milder surfactant formulation.

Described in US 2018/0016523, the entire contents of which are incorporated by reference herein, are methods for determining how mild an aqueous laundry detergent formulation is for a user. The method comprises the steps of: (i) providing a solution comprising a laundry cleaning effective amount of a surfactant composition, (ii) subjecting an appropriate dilution of the solution to Zein test, corneosurfametry test, and in vitro cytokine release test for IL-1a and IL-1ra response, respectively, to obtain a Zein score, a corneosurfametric (CSM) value, and a cytokine release value, and (iii) deriving at composite mildness indicator (CMI) for each solution based the Zein score, the CSM value, and the cytokine release value.

The composite mildness indicator (CMI) may also be called detergent mildness indicator (DMI). Specifically, the CMI can be derived from (1) the Zein score, CSM value, and cytokine release value IL-1a of the formulation; (2) the Zein score, CSM value, and cytokine release value (IL-1a+IL-1ra) of the formulation; (3) the Zein score, CSM value, and cytokine release value (IL-1ra/IL-1a) of the formulation; (4) the Zein score, CSM value, and cytokine release value log10 (IL-1ra/IL-1a) of the formulation; or (5) the Zein score, CSM value, and cytokine release measurement (IL-1α/IL-1ra) of the formulation.

### EXAMPLES

### Example 1—Peptides as Chlorine Scavengers in Laundry Detergents

The following formulations were batched using a standard overhead mixer and will be referred to “Formula 1 and 2” as listed below in Table 1:

TABLE 1

| | Raw | Wt % of | Wt % of |
|---|---|---|---|
| | Material | Formula 1 | Formula 2 |
| Component | Activity | (Control) | (Inventive) |
| Water, demineralized | 100 | q/s to 100 | q/s to 100 |
| | | (about 56%) | (about 56%) |
| Citric Acid | 50 | 0.2 | 0.2 |
| Sodium tetraborate 5H₂O | 100 | 0.5 | 0.5 |
| 50% NaOH | 50 | 2.4 | 2.4 |
| Fatty alcohol ethoxylate (non-ionic | 100 | 16.2 | 16.2 |
| surfactant) | | | |
| Sodium Laureth Sulfate, 3EO | 29 | 5.5 | 5.5 |
| (anionic surfactant) | | | |
| Coconut Fatty Acid, Anti- | N/A | 5 | 5 |
| redeposition Polymer, Chelating | | | |
| agent, Preservative, Aqueous | | | |
| Enzyme Solution (Protease, | | | |
| Amylase, Mannanase blend), | | | |
| Propylene Glycol/Ethanol | | | |
| Linear Alkyl Benzene Sulfonic | 96 | 9 | 9 |
| Acid | | | |
| Peptide | 50 | 0 | 0.5 |

The target dose of detergent per wash was 45 grams, and the estimated amount of water in a High Efficiency Washing Machine was 31.4 L. Proportionally, 1.43 grams of detergent was added into 1 L of water for benchtop scale.

With a starting chlorine concentration of 1 ppm of hypochlorite in the water, the results in Table 2 were observed after adding 1.43 grams of Formula 1, 2, or 3 to 1 L of the chlorinated water. Formula 2 had L-Lysine 50% solution substituted for the peptide since the peptide was not available for testing.

TABLE 2

| | | | Chlorine Concentration | | | |
|---|---|---|---|---|---|---|
| | | Initial | after Contact with | | | |
| | | Chlorine | Formula (ppm) | | | |
| | Solution | Concentration | 15 | 30 | 60 | 120 |
| Formula | Agitated | (ppm) | sec | sec | sec | sec |
| 1 (control) | Yes | 1 | 0.5 | 0.5 | 0 | 0 |
| 2 (inventive) | Yes | 1 | 0 | 0 | 0 | 0 |

An exemplary enzymatic formulation containing peptides are described below in Table 3:

TABLE 3

| | Raw | | | | |
|---|---|---|---|---|---|
| | Material | Formula | Formula | Formula | Formula |
| | Activity | 5 | 6 | 7 | 8 |
| Water softened | 100.00% | q/s | q/s | q/s | q/s |
| | | to 100 | to 100 | to 100 | to 100 |
| Laureth-6 plant-based | 100.00% | 27.2 | 27.2 | 27.2 | 27.2 |
| EO, Anionic | | | | | |
| Surfactant and Fatty | | | | | |
| Acid | | | | | |
| Citric acid 50% | 50.00% | 4.500 | 4.500 | 4.500 | 4.500 |
| solution | | | | | |
| Sodium hydroxide | 50.00% | Adjust- | Adjust- | Adjust- | Adjust- |
| 50% (Membrane | | ed to | ed to | ed to | ed to |
| grade) | | pH 8 | pH 8 | pH 8 | pH 8 |
| Peptide | 50% | 0.25 | 0.5 | 0.75 | 1 |
| Polymer, Chelant, | N/A | 2.672 | 2.672 | 2.672 | 2.672 |
| Preservative | | | | | |
| Protease, Amylase, | 100.00% | 2.1 | 2.1 | 2.1 | 2.1 |
| Mannanase Blend | | | | | |

Further, a high pH, non-enzymatic formula example is as followed in Table 4:

TABLE 4

| | Raw | Formula | |
|---|---|---|---|
| | Material | 14 | Formula |
| Component | Activity | (standard) | 15 |
| Water | 100% | q/s to 100 | q/s to 100 |
| Nonionic surfactant | Approx. 88% | 17.14 | 17.14 |
| (fatty alcohol ethoxylate C₁₂₋₁₅ | as a blend | | |
| 7EO) and Anionic surfactant | | | |
| (sodium laureth sulfate, 3EO) | | | |
| Anionic surfactant/Defoamer | 100% | 10.95 | 10.95 |
| (coconut fatty acid derived from | | | |
| palm) and sodium carbonate and | | | |
| Optical Brightener and Anti- | | | |
| Redeposition Polymer and | | | |
| Preservative | | | |
| Chelating agent | 34% | 1.18 | 1.18 |
| (tetrasodium iminodisuccinate) | | | |
| Peptide | 50% | — | 0.15 |

Especially peptides which have domains that show affinity to bind to different types of textiles and do contain a high number of amino acids which are susceptible to oxidation (like i.e., Methionine, Lysine, Cysteine, and others) are most preferred. The most effective peptides are expected to be in the length range of 10-60 amino acids and do contain at least two, preferably more than two amino acids susceptible to oxidation. Furthermore, peptides according to various aspects of the disclosure can include one or more linking domains such as, for example, SEQ ID NO: 13-24 (see Table 6).

### Example 3—Small Scale Evaluation of Chlorine Scavenging Carry-Over

The following is an example of a small-scale method for evaluating the efficacy of reagents for binding to fabric and scavenging free chlorine in a simulated wash and rinse cycle.

A 300 mL glass beaker equipped with a cross-shaped stir bar was used as the washing/rinsing vessel. About 150 grams of prepared water was weighed into the beaker. The water was prepared with 120 ppm hardness (calcium and magnesium, 3:1 ratio), and 3 ppm free chlorine via a bleach solution. The free chlorine level was monitored using an Insta-Test Analytic free chlorine test strip from LaMotte. The wash water was heated on a hot plate to 90° F. (32° C.).

The peptide of interest was injected into the wash water via a micropipette. For the reported tests, a 1% by weight solution of the selected peptide in deionized water was prepared and injected into the wash water to deliver 5 mg of active ingredient (0.5 mL). The peptide solution was stirred for 1 minute.

Pre-cut cotton/polyester fabric sheets (55/45 ratio from SDL Atlas), weighed out to 4 grams, were added directly to the wash water. The water, peptide, and ballast mixture were allowed to stir for 12 minutes. Afterwards, the ballast was removed from the water and placed in a device which applied a centrifugal force to remove excess water from the sample. The ballast was spun out for ˜2 minutes.

Separately, a new 300 ml beaker was prepared with 150 grams of water (120 ppm hardness, 3 ppm free chlorine) to simulate the rinse cycle. The temperature was set to 60° F. (˜15.5° C.). The free chlorine level was checked with a test strip. The treated ballast was added to the rinse water and stirred for 4 minutes. The chlorine scavenging rate was monitored by using the free chlorine test strips (e.g., at 4 minutes).

### Results

The small-scale evaluation of chlorine scavenging was conducted using a peptide comprising SEQ ID NO: 11 (RALRALQALEALEALGGGGSMDMQGRYMDR). Table 5 below shows the free chlorine level (FCL) in the simulated rinse water over the course of 4 minutes, as determined based on the visual indicator test strips. It was observed that SEQ ID NO: 11 was able to scavenge hypochlorite in the simulated rinse water.

TABLE 5

| | | |
|---|---|---|
| Dose | Start ppm | 4 minutes |

| | | |
|---|---|---|
| Peptide comprising SEQ | 3 | 2.5 |
| ID NO: 11 | | |

Table 6 lists various sequences used in the detergent compositions.

TABLE 6

| SEQ | |
|---|---|
| ID | |
| NO | Sequence |
| 1 | NGLLIPQFLVASGGGGSRSIVTFSLRQNRGGGGSN |
| | GLLIPQFLVAS |
| 2 | NGLLIPQFLVASGGGGSRALQALRALQALEALGGG |
| | GSNGLLIPQFLVAS |
| 3 | NGLLIPQFLVASGGGGSRALRALQALEALEALGGG |
| | GSNGLLIPQFLVAS |
| 4 | RSIVTFSLRQNR |
| 5 | RALQALRALQALEAL |
| 6 | RALRALQALEALEAL |
| 7 | NGLLIPQFLVASGGGGSMSDYQMDM |
| 8 | RALRALQALEALEALGGGGSMSDYQMDM |
| 9 | RALQALRALQALEALGGGGSMSDYQMDM |
| 10 | NGLLIPQFLVASGGGGSMDMQGRYMDR |
| 11 | RALRALQALEALEALGGGGSMDMQGRYMDR |
| 12 | RALQALRALQALEALGGGGSMDMQGRYMDR |
| 13 | GGGGS |
| 14 | GGGGSGGGGS |
| 15 | GGGGSGGGGSGGGGS |
| 16 | GGGGSGGGGSGGGGSGGGGGGS |
| 17 | GGGGGGGG |
| 18 | GGGGGG |
| 19 | EAAAK |
| 20 | EAAAKEAAAK |
| 21 | EAAAKEAAAKEAAAK |
| 22 | AEAAAKEAAAKEAAAKEAAAKALEAAAAAKEAAAKE |
| | AAAKEAAAKA |
| 23 | AEAAAKEAAAKA |
| 24 | PAPAP |

1. A liquid detergent composition comprising:
a peptide in an amount ranging from about 0.01 to about 5 wt % of the detergent composition, the peptide comprising:
one or more binding domains, the binding domains having a binding affinity to a textile; and
two or more amino acids susceptible to oxidation;
a non-ionic surfactant in an amount ranging from about 1 to about 30 wt % of the detergent composition;
an anionic surfactant in an amount ranging from about 1 to about 35 wt % of the detergent composition; and
water.

2. The detergent composition of claim 1, wherein the peptide further comprises a linking domain.

3. The detergent composition of claim 2, wherein the linking domain comprises GGGGS (SEQ ID NO: 13) or EAAAK (SEQ ID NO: 19).

4. The detergent composition of claim 1, wherein the peptide has a length of about 5 to about 70 amino acids.

5. The detergent composition of claim 1, wherein the peptide has a length of about 10 to about 60 amino acids.

6. The detergent composition of claim 1, wherein about 3.3% to about 20% of the amino acids in the peptide are amino acids susceptible to oxidation.

7. The detergent composition of claim 1, wherein about 10 to about 60 amino acids in the peptide are amino acids susceptible to oxidation.

8. The detergent composition of claim 1, wherein the amino acids susceptible to oxidation are cysteine, histidine, methionine, arginine, or lysine.

9. The detergent composition of claim 1, wherein each amino acid susceptible to oxidation is no more than 5 amino acids away from an amino acid in one of the one or more binding domains.

10. The detergent composition of claim 1, wherein the peptide comprises:
SEQ ID NO. 1:
NGLLIPQFLVASGGGGSRSIVTFSLRQNRGGGG
SNGLLIPQFLVAS;
SEQ ID NO. 2:
NGLLIPQFLVASGGGGSRALQALRALQALEALGG
GGSNGLLIPQFLVAS;
SEQ ID NO. 3:
NGLLIPQFLVASGGGGSRALRALQALEALEALGG
GGSNGLLIPQFLVAS;
SEQ ID NO. 4:
RSIVTFSLRQNR;
SEQ ID NO. 5:
RALQALRALQALEAL;
or
SEQ ID NO. 6:
RALRALQALEALEAL.

11. The detergent composition of claim 1, wherein the peptide comprises:
SEQ ID NO. 7:
NGLLIPQFLVASGGGGSMSDYQMDM;
SEQ ID NO. 8:
RALRALQALEALEALGGGGSMSDYQMDM;
SEQ ID NO. 9
RALQALRALQALEALGGGGSMSDYQMDM;
SEQ ID NO. 10:
NGLLIPQFLVASGGGGSMDMQGRYMDR;
SEQ ID NO. 11:
RALRALQALEALEALGGGGSMDMQGRYMDR;
or
SEQ ID NO. 12:
RALQALRALQALEALGGGGSMDMQGRYMDR.

12. The detergent composition of claim 1, wherein the textile is made of a natural material, a synthetic material or a blend thereof.

13. The detergent composition of claim 1, wherein the detergent composition further comprises at least one of:
a fatty acid in an amount ranging from about 0.1 to about 3 wt % of the detergent composition;
a strong base in an amount ranging from about 0.1 to about 10 wt % of the detergent composition;
a weak acid in an amount ranging from about 1 to about 9 wt % of the detergent composition;
an anti-redeposition polymer in an amount ranging from about 0.1 to about 3 wt % of the detergent composition;
a preservative in an amount ranging from about 0.01 to about 2 wt % of the detergent composition;
a chelating agent in an amount ranging from about 0.1 to about 3 wt % of the detergent composition;
a linear alkyl benzene sulfonic acid in an amount ranging from about 5 to about 10 wt % of the detergent composition;
a microbiocide, an algicide, and a fungicide in an amount ranging from about 0.01 to about 3 wt % of the detergent composition;
an aqueous enzyme solution in an amount ranging from about 0.1 to about 5 wt % of the detergent composition;
wherein the aqueous enzyme solution comprises a protease, a mannanase, and an amylase;
a sodium tetraborate in an amount ranging from about 0.1 to about 3 wt % of the detergent composition; and
a sodium lauryl sulfate in an amount ranging from about 2 to about 10 wt % of the detergent composition.

14. The detergent composition of claim 1, wherein the detergent composition further comprises:
propylene glycol in an amount ranging from about 0.1 to about 5 wt % of the detergent composition; and
ethanol in an amount ranging from about 0.1 to about 5 wt % of the detergent composition.

15. The detergent composition of claim 1, further comprising one or more of:
a defoamer;
a buffer;
optical brightener;
a chelating agent
an anti-redeposition polymer;
a preservative; and
wherein the pH of the detergent composition ranges from about 10 to about 12.

16. The detergent composition of claim 14, wherein the total amount of the one or more of the defoamer, sodium carbonate, chelating agent, optical brightener, anti-redeposition polymer, and preservative are in an amount ranging from about 5 to about 25 wt % of the detergent composition.

17. The detergent composition of claim 1, wherein the pH of the detergent composition ranges from about 7 to about 10.

18. The detergent composition of claim 1, wherein the pH of the detergent composition ranges from about 10 to about 12.

19. A method of cleaning textiles, the method comprising:
combining an amount of the detergent composition of claim 1 with an amount of water to form a diluted detergent composition having from about 1 to about 2 grams of the detergent composition per liter of water; and
cleaning the textiles using the diluted detergent composition.

20. The method of claim 19, wherein the textiles are made of natural materials, synthetic materials or blends thereof.
